(19) United States
(12) Patent Application Publication
(10) Pub. No.: US 2014/0369618 A1
(43) Pub. Date: Dec. 18, 2014

(54) ENCODING DEVICE AND MONITORING SYSTEM

(71) Applicant: Kabushiki Kaisha Toshiba, Tokyo (JP)

(72) Inventors: Saori ASAKA, Yokohama-shi (JP); Takeshi CHUJOH, Kawasaki-shi (JP); Wataru ASANO, Yokohama-shi (JP); Hiroyuki KOBAYASHI, Tsukubamirai-shi (JP)

(73) Assignee: Kabushiki Kaisha Toshiba, Tokyo (JP)

(21) Appl. No.: 14/165,610

(22) Filed: Jan. 28, 2014

(30) Foreign Application Priority Data
Jun. 14, 2013 (JP) 2013-125959

(51) Int. Cl. H04N 19/37

(52) U.S. Cl. CPC H04N 19/00454
USPC 382/243

(57) ABSTRACT

According to an embodiment, an encoding device includes an area setting unit, a parameter controller, and an encoder. The area setting unit is configured to, in an image captured by an imager mounted on a vehicle while the vehicle is moving along a predetermined route, set a boundary in the image at a predetermined distance from the imager, a first area being an area inside of the boundary, and a second area being an area outside of the boundary. The parameter controller is configured to control an encoding parameter to assign a larger code amount to the first area than to the second area. The encoder is configured to encode the image in accordance with the encoding parameter.

### CROSS-REFERENCE TO RELATED APPLICATION(S)

This application is based upon and claims the benefit of priority from Japanese Patent Application No. 2013-125959, filed on Jun. 14, 2013; the entire contents of which are incorporated herein by reference.

### FIELD

Embodiments described herein relate generally to an encoding device and a monitoring system.

### BACKGROUND

An area in an image at a longer distance from an imager that captured the image has weaker edges and higher complexity. Thus, when the image is encoded, the influence of degradation caused by encoding is greater on areas at longer distances from the imager.

Techniques of assigning the code amount to a subject in an image on the basis of the edge strength of each unit area in the image or the distance of each unit area from an imager are thus known.

With the techniques of the related art as described above, however, the influence of degradation caused by encoding on an area in an image on which the user wants to focus cannot always be eliminated.

### BRIEF DESCRIPTION OF THE DRAWINGS

FIG. 1 is a configuration diagram illustrating an example of an inspection system according to a first embodiment;

FIG. 2 is a configuration diagram illustrating an example of an encoding device according to the first embodiment;

FIG. 3 is an explanatory diagram of an example of a technique for detecting a most distant area according to the first embodiment;

FIG. 4 is an explanatory diagram of the example of the technique for detecting a most distant area according to the first embodiment;

FIG. 5 is an explanatory diagram of the example of the technique for detecting a most distant area according to the first embodiment;

FIG. 6 is an explanatory diagram of the example of the technique for detecting a most distant area according to the first embodiment;

FIG. 7 is an explanatory diagram of an example of a technique for detecting a most distant area according to the first embodiment;

FIG. 8 is an explanatory diagram of the example of the technique for detecting a most distant area according to the first embodiment;

FIG. 9 is an explanatory diagram of the example of the technique for detecting a most distant area according to the first embodiment;

FIG. 10 is an explanatory diagram of the example of the technique for detecting a most distant area according to the first embodiment;

FIG. 11 is an explanatory diagram of an example of a boundary area, a first area, and a second area according to the first embodiment;

FIG. 12 is an explanatory diagram of an example of the boundary area, the first area, and the second area according to the first embodiment;

FIG. 13 is an explanatory diagram of an example of a technique for setting the first area according to the first embodiment;

FIG. 14 is an explanatory diagram of an example of the technique for setting the first area according to the first embodiment;

FIG. 15 is an explanatory diagram of an example of the technique for setting the first area according to the first embodiment;

FIG. 16 is an explanatory diagram of an example of the technique for setting the first area according to the first embodiment;

FIG. 17 is an explanatory diagram of an example of the technique for setting the first area according to the first embodiment;

FIG. 18 is an explanatory diagram of an example of the technique for setting the first area according to the first embodiment;

FIG. 19 is an explanatory diagram of an example of the technique for setting the first area according to the first embodiment;

FIG. 20 is an explanatory diagram of an example of the technique for setting the first area according to the first embodiment;

FIG. 21 is an explanatory diagram of an example of processing for decreasing the resolution according to the first embodiment;

FIG. 22 is an explanatory diagram of the example of the processing for decreasing the resolution according to the first embodiment;

FIG. 23 is a configuration diagram illustrating an example of a decoding device according to the first embodiment;

FIG. 24 is an explanatory diagram of an example of processing for increasing the resolution according to the first embodiment;

FIG. 25 is a flowchart illustrating exemplary processing according to the first embodiment;

FIG. 26 is a diagram illustrating an exemplary configuration of an encoding device according to a second embodiment;

FIG. 27 is a diagram illustrating an exemplary configuration of an encoding device according to a third embodiment;

FIG. 28 is a diagram illustrating an example of a rate control method according to the third embodiment;

FIG. 29 is a diagram illustrating an example of a rate control method according to the third embodiment;

FIG. 30 is a diagram illustrating the example of the rate control method according to the third embodiment;

FIG. 31 is a diagram illustrating an exemplary configuration of an encoding device according to a fourth embodiment; and

FIG. 32 is a diagram illustrating an example of block distance information according to the fourth embodiment.

### DETAILED DESCRIPTION

According to an embodiment, an encoding device includes an area setting unit, a parameter controller, and an encoder. The area setting unit is configured to, in an image captured by an imager mounted on a vehicle while the vehicle is moving along a predetermined route, set a boundary in the image at a predetermined distance from the imager, a first area being an area inside of the boundary, and a second area being an area outside of the boundary. The parameter controller is configured to control an encoding parameter to assign a larger code amount to the first area than to the second area. The encoder is configured to encode the image in accordance with the encoding parameter.

Embodiments will be described in detail below with reference to the accompanying drawings.

### First Embodiment

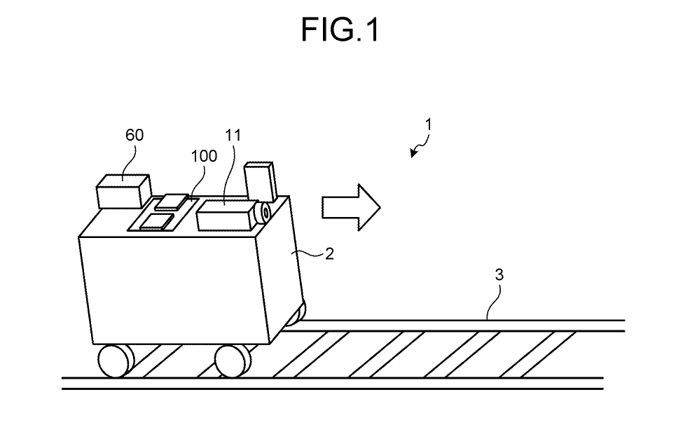

FIG. 1 is a configuration diagram illustrating an example of an inspection system 1 according to a first embodiment. As illustrated in FIG. 1, the inspection system 1 includes a mobile object 2, an imager 11, an encoding device 100, and a transmitter 60. The mobile object 2 moves on a predetermined path 3 (a track, for example) and has mounted thereon the imager 11, the encoding device 100, and the transmitter 60. The imager 11 captures images ahead in the moving direction in time series while the mobile object 2 is moving, the encoding device 100 encodes the images captured by the imager 11, and the transmitter 60 transmits the images resulting from encoding by the encoding device 100 to a predetermined destination such as a management center. The predetermined destination such as a management center then uses the images transmitted from the inspection system 1 for remote inspection of the path 3.

With such an inspection system 1, to remotely control the movement of the mobile object 2, a supervisor sees images transmitted from the inspection system 1 and instructs to stop, etc., the mobile object 2. To stop the mobile object 2 at a desired stop position, the supervisor needs to check the vicinity of the stop position in the images transmitted from the inspection system 1.

Since, however, the mobile object 2 is moving, there is a distance between the vicinity of the stop position and the imager 11. Thus, the supervisor attempting to check the vicinity of the stop position in the image may fail to grasp the state in the vicinity of the stop position owing to degradation caused by encoding and fail to stop the mobile object 2 at the stop position.

Thus, in the first embodiment, a larger code amount is assigned to an area in an image on which the user wants to focus for encoding so that the influence of degradation caused by encoding on the area will be reduced.

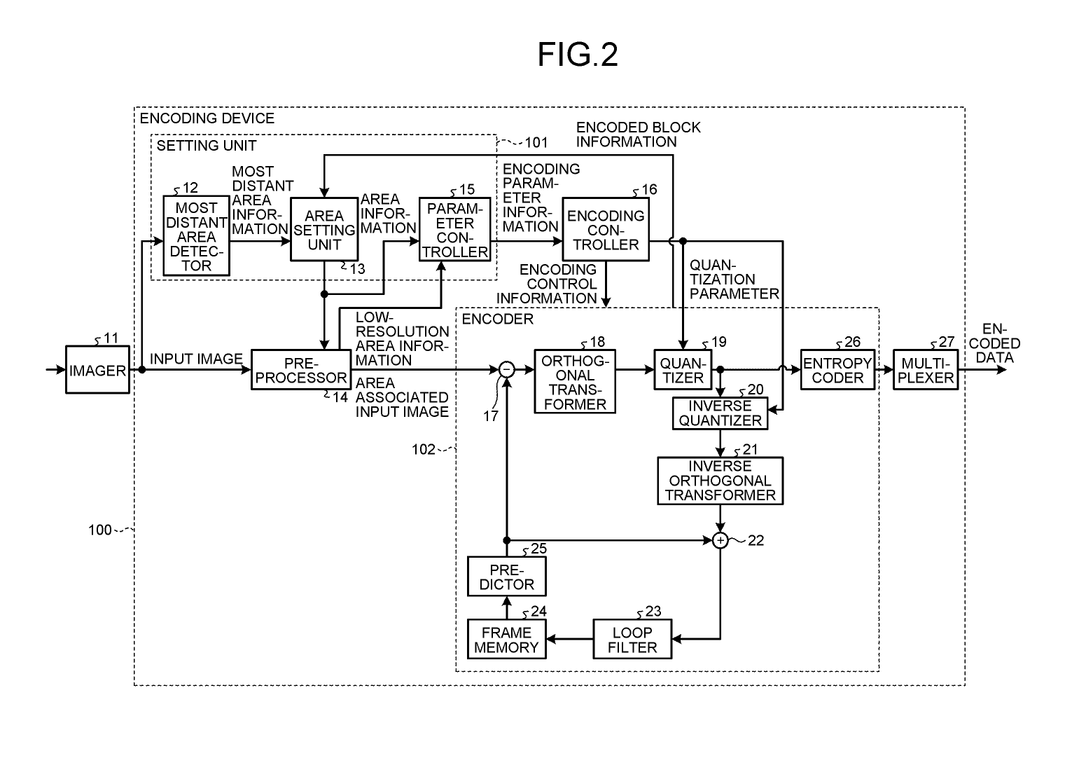

FIG. 2 is a configuration diagram illustrating an example of the encoding device 100 according to the first embodiment. As illustrated in FIG. 2, the encoding device 100 includes a setting unit 101, a preprocessor 14, an encoding controller 16, an encoder 102, and a multiplexer 27.

The setting unit 10 includes a most distant area detector 12, an area setting unit 13, and a parameter controller 15. The encoder 102 includes a subtractor 17, an orthogonal transformer 18, a quantizer 19, an inverse quantizer 20, an inverse orthogonal transformer 21, an adder 22, a loop filter 23, a frame memory 24, a predictor 25, and an entropy coder 26.

An image (input image) captured by the imager 11 is input to the most distant area detector 12 and the preprocessor 14. The imager 11 can be realized by a video camera or a digital camera.

The most distant area detector 12 detects a most distant area that is an area on the path 3 in the image captured by the imager 11 and at the farthest distance from the imager 11. Note that the size of the most distant area can be set to any size such as the size of a pixel or the size of a block of N×N pixels.

Specifically, the most distant area detector 12 performs edge detection of an object to be visually observed on the image captured by the imager 11, performs line and curve detection on the basis of the result of the edge detection, and detects an area in which the most lines and curves intersect to be the most distant area. In the first embodiment, the line and curve detection allows detection of lines or curves along the path or an overhead wire.

Examples of the edge detection technique that can be used include the Canny method, Roberts operator, and Sobel operator. In addition, examples of the line and curve detection technique that can be used include the Hough transform.

The most distant area detector 12 preferably performs line detection if the path 3 is arranged linearly or curve detection if the path 3 is curved, but may alternatively perform both detections and apply the one with a favorable result.

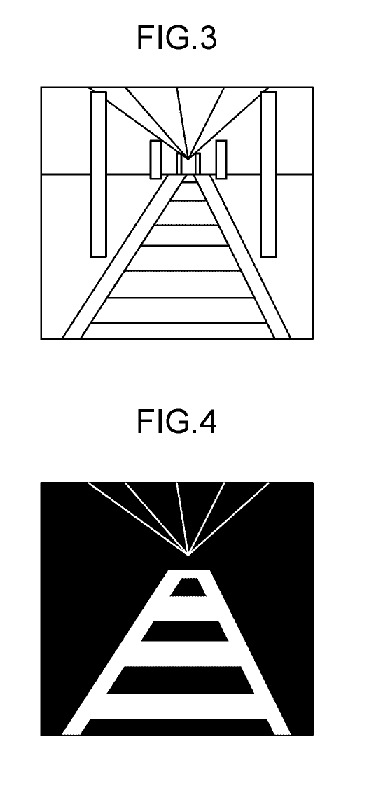

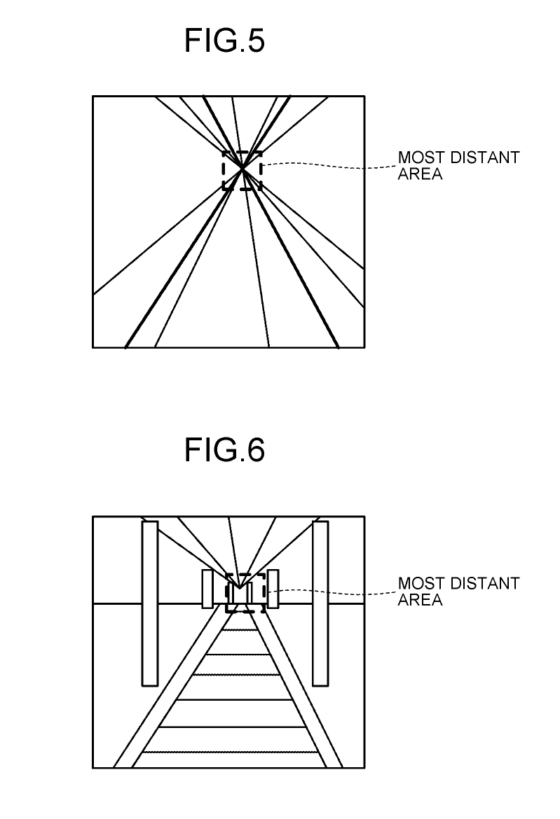

Assume, for example, that the path 3 is arranged linearly in an image captured by the imager 11 (see FIG. 3). In this case, the most distant area detector 12 performs edge detection on the image (see FIG. 4), performs line detection based on the result of the edge detection, detects an area in which the most detected lines intersect to be the most distant area (see FIG. 5), and sets the detected most distant area in the image (see FIG. 6).

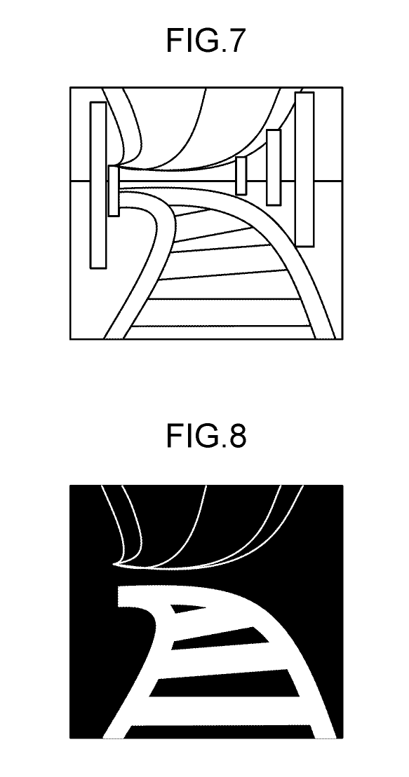

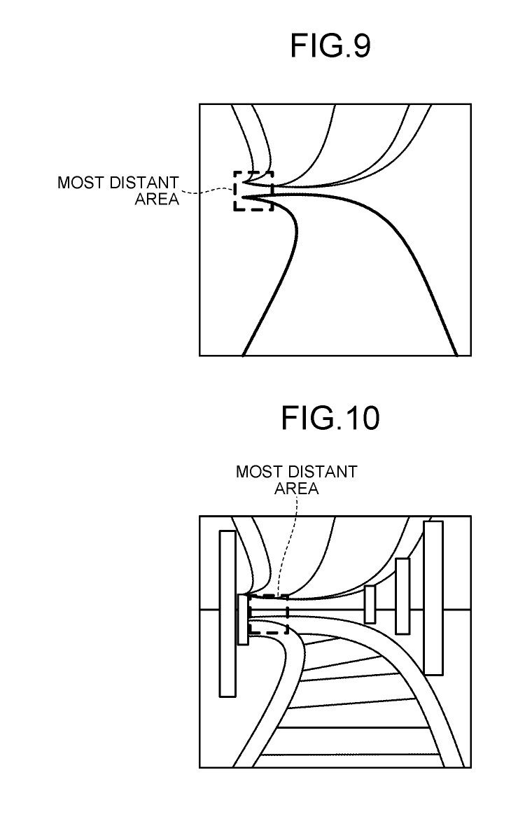

Alternatively, assume, for example, that the path 3 is curved in an image captured by the imager 11 (see FIG. 7). In this case, the most distant area detector 12 performs edge detection on the image (see FIG. 8), performs curve detection based on the result of the edge detection, detects an area in which the most detected lines intersect to be the most distant area (see FIG. 9), and sets the detected most distant area in the image (see FIG. 10).

It is assumed in the first embodiment that the line and curve detection is performed on the entire image, but the line and curve detection is not limited thereto and may alternatively be performed only on areas in which lines or curves are likely to be detected (for example, areas lower than the middle of the screen).

The image (most distant area information) in which the most distant area is set by the most distant area detector 12 is input to the area setting unit 13.

The area setting unit 13 sets a boundary area at a predetermined distance from the imager 11 in the image captured by the imager 11, sets an area inner than the boundary area to be a first area, and sets the area outer than the boundary area to be a second area. Specifically, the area setting unit 13 sets an area inner than the boundary area to be the first area on the basis of the most distant area detected by the most distant area detector 12. Note that the area setting unit 13 may be capable of setting the boundary area for each frame and set the boundary area where necessary.

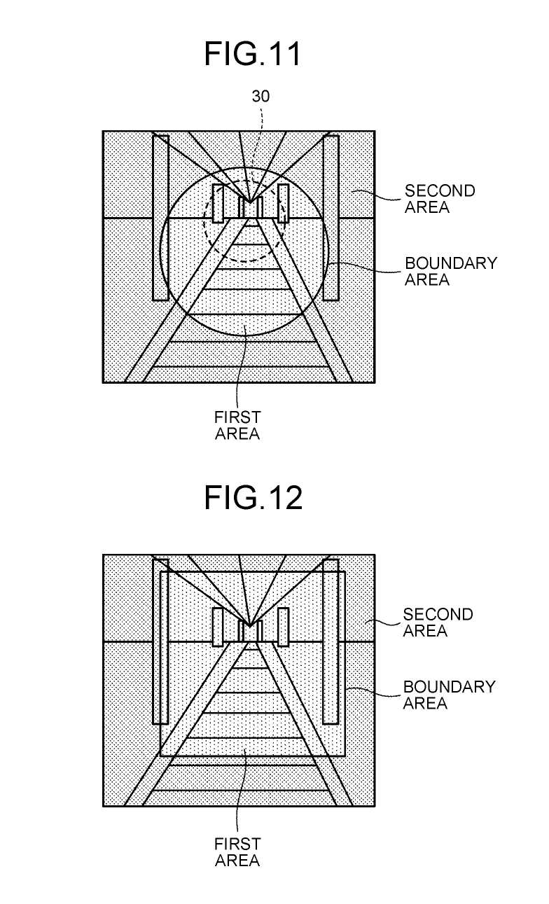

FIG. 11 is an explanatory diagram of an example of the boundary area, the first area, and the second area according to the first embodiment. When the mobile object 2 stops from a state in which the mobile object 2 is moving at 30 kilometers per hour, the stop position of the mobile object 2 will be a position about 30 meters ahead of the current position of the mobile object 2. In the example illustrated in FIG. 11, the stop position of the mobile object 2 is within the range surrounded by a dotted line 30, that is, a position close to the most distant area detected by the most distant area detector 12.

Thus, the area setting unit 13 determines the predetermined distance so that the stop position of the mobile object 2, that is, the position close to the most distant area detected by the most distant area detector 12 is included in the area inner than the boundary area to set the boundary area. The area setting unit 13 then sets an area inner than the boundary area to be the first area, and the area outer than the boundary area to be the second area.

While the boundary area has a circular shape in the example illustrated in FIG. 11, the boundary area is not limited thereto and may have a rectangular shape (see FIG. 12) or other shapes.

More specifically, the area setting unit 13 draws two first lines from the most distant area to a lower side of the boundary area, and sets the area surrounded by the most distant area, the lower side of the boundary area, and the two first lines to be the first area. The area setting unit 13 also draws two second lines from the most distant area to an upper side of the boundary area, and further sets the area surrounded by the most distant area, the upper side of the boundary area, and the two second lines to be the first area. In this case, the area setting unit 13 sets the area inner than the boundary area but outside of the first area to be a third area.

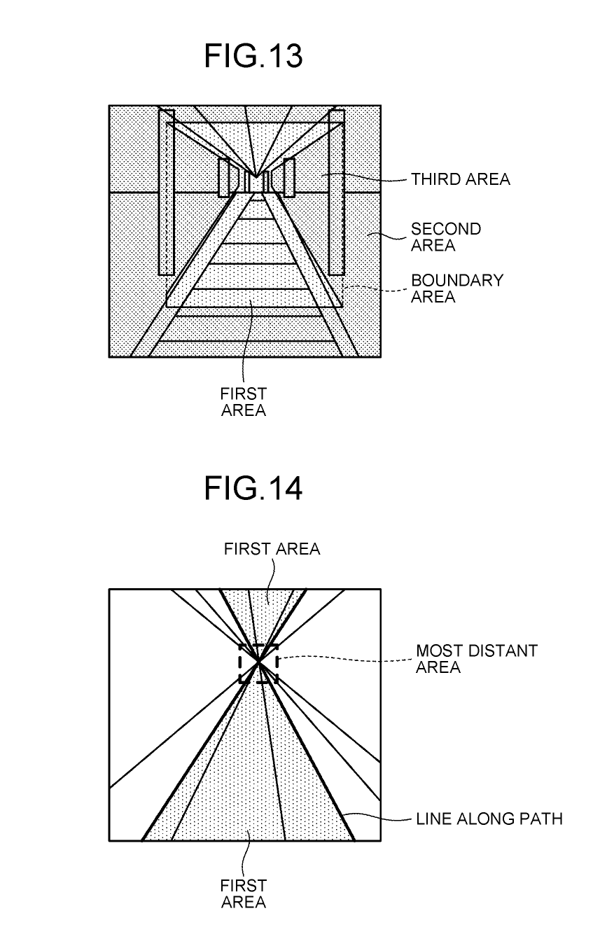

For example, the two first lines can be a line connecting the left end of the lower side of the most distant area and the left end of the lower side of the boundary area and a line connecting the right end of the lower side of the most distant area and the right end of the lower side of the boundary area (see FIG. 13). Similarly, the two second lines can be a line connecting the left end of the upper side of the most distant area and the left end of the upper side of the boundary area and a line connecting the right end of the upper side of the most distant area and the right end of the upper side of the boundary area (see FIG. 13). Note that the two first lines and the two second lines may be curves.

Alternatively, for example, the two first lines can be lines along outer edges of the path 3 (see FIG. 14). Similarly, the two second lines can be lines along outer edges of the overhead wire (see FIG. 14). The lines along the outer edges of the path 3 and the lines along the outer edges of the overhead wire can be lines detected by the line detection performed by the most distant area detector 12, for example. Note that the lines to be used are innermost or outermost lines or lines passing along edges of objects (the path and the overhead wire) that are most likely to be the objects to be visually observed. Also note that the two first lines and the two second lines may be curves.

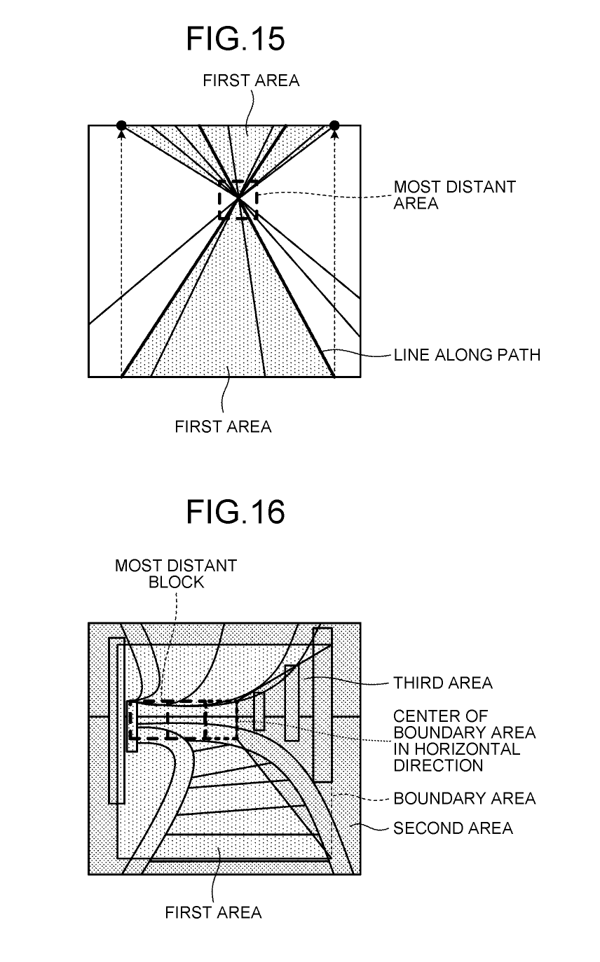

Alternatively, for example, the two second lines can be lines connecting the most distant area and intersection points of the upper side of the boundary area and lines perpendicular thereto passing through intersections of the two first lines and the lower side of the boundary area (see FIG. 15). Note that the two second lines may be curves.

Alternatively, for example, the two first lines can be a line connecting the left end of the lower side of the most distant area and the left end of the lower side of the boundary area and a line connecting the right end of the lower side of the most distant area and the right end of the lower side of the boundary area (see FIG. 16). Similarly, the two second lines can be a line connecting the left end of the upper side of the most distant area and the left end of the upper side of the boundary area and a line connecting the right end of the upper side of the most distant area and the right end of the upper side of the boundary area (see FIG. 16).

In the example illustrated in FIG. 16, however, the path 3 is curved in the image captured by the imager 11, and thus the area setting unit 13 redefines a rectangular area including the most distant area and center areas in the images located in the horizontal direction of the most distant area as the most distant area. The technique for redefining the most distant area is not limited thereto, and a rectangular area including the most distant area and the center area of the boundary area, for example, may be redefined as the most distant area, or a rectangular area including the most distant area and the center area at a fixed position in the image may be redefined as the most distant area.

An example of the method for determining whether the path 3 is linear or curved in an image captured by the imager 11 is a method of determining the path 3 to be curved when the most distant area is away from the central position in the horizontal direction of the image, the boundary area, or the fixed position by M or more blocks and determining the path 3 not to be curved when the most distant area is away therefrom by M or less blocks. M may be a value determined on the basis of the position at which the imager 11 is installed.

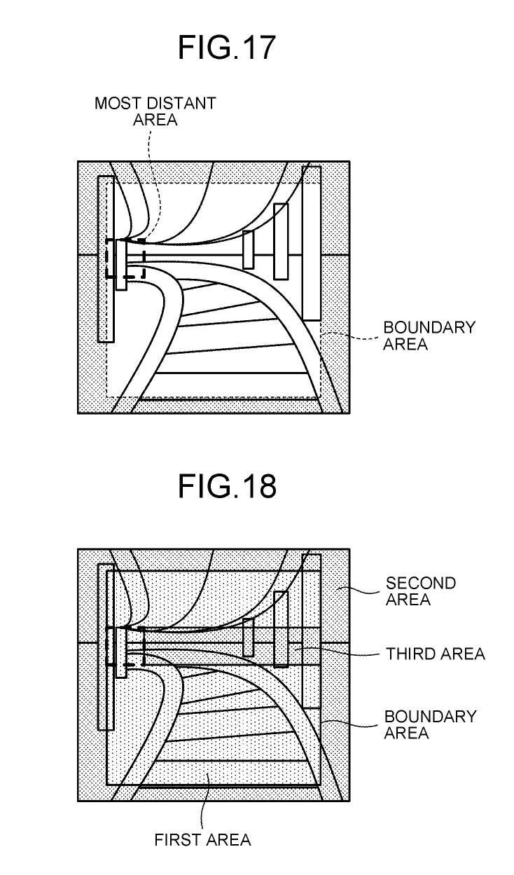

Alternatively, for example, when either left or right side of the most distant area overlaps with the right or left side of the boundary area as illustrated in FIG. 17, the area setting unit 13 may draw a horizontal line from the end point of the side, which does not overlap with the boundary area, of the most distant area, and set the area surrounded by the most distant area, the boundary area, and the horizontal line to be the first area as illustrated in FIG. 18.

Furthermore, the area setting unit 13 may change the number of most distant areas to set the first area. When the number of most distant areas is one, for example, the most distant area detected by the most distant area detector 12 is used similarly to above.

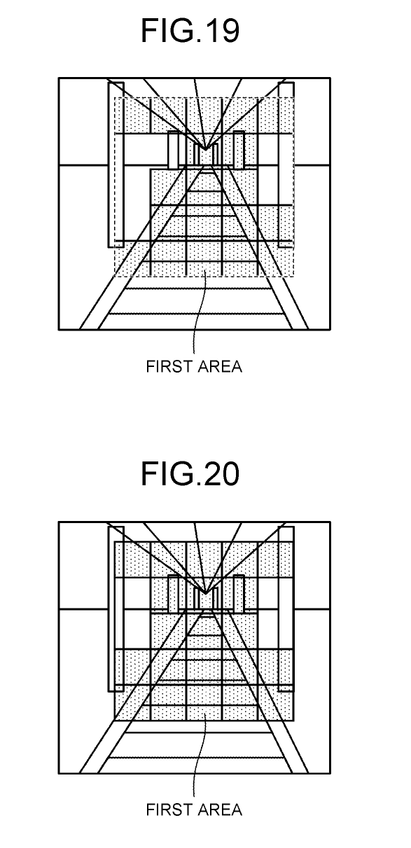

When the number of most distant areas is two, for example, an area adjacent to either the left or right of the most distant area detected by the most distant area detector 12 may also be defined as a most distant area. For example, the area setting unit 13 may count intersections of lines or curves used for detecting the most distant area by the most distant area detector 12 on the left and on the right of the most distant area, and use the adjacent area with more intersections as a most distant area. In this case, the first area in the image will be as illustrated in FIG. 19.

When the number of most distant areas is three, for example, both of the areas adjacent to the left and to the right of the most distant area detected by the most distant area detector 12 may also be defined as most distant areas. In this case, the first area in the image will be as illustrated in FIG. 20.

Among areas along lines or curves, an area in which the center position of the areas or any of four corner points of the areas is located can be defined as the first area or an area having a large area ratio can be defined as the first area.

The area setting unit 13 then generates area information indicating an area to which a block to be encoded belongs from encoded block information input from the encoder 102, and outputs the area information to the preprocessor 14 and the parameter controller 15.

The preprocessor 14 performs preprocessing such as image processing for improving the image quality of the first area set by the area setting unit 13 and reducing the code amounts of the second area and the third area set by the area setting unit 13. Specifically, the preprocessor 14 performs sharpening by applying an unsharp mask to the object to be visually observed and adjustment of luminance to facilitate visual observation of the object on the first area, and makes the second area and the third area monochrome to reduce the color components and performs smoothing using a Gaussian filter or a moving average filter on the second area and the third area to reduce the complexity on the basis of the area information from the area setting unit 13.

The preprocessor 14 also decreases the resolution of the second area through pixel thinning. When the resolution is decreased, the preprocessor 14 then outputs low-resolution area information containing the area whose resolution is decreased and the resolution decrease rate to the parameter controller 15.

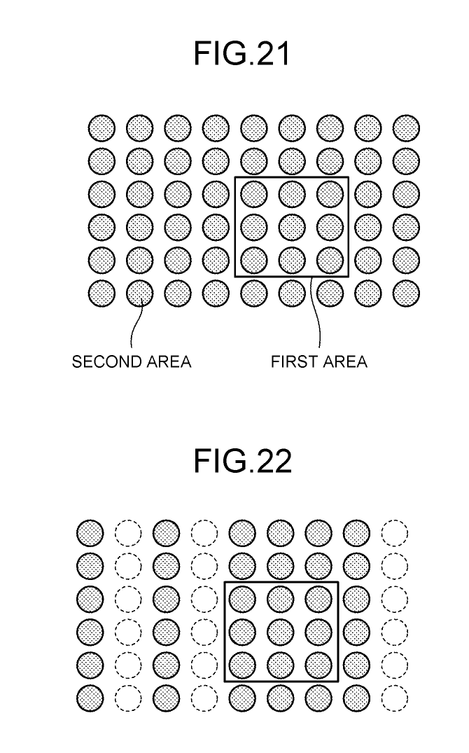

FIGS. 21 and 22 are explanatory diagrams of an example of the processing for decreasing the resolution according to the first embodiment. First, as illustrated in FIG. 21, it is assumed that the area within a frame is the first area and the area outside of the frame is the second area. The preprocessor 14 then decreases the resolution of the second area as illustrated in FIG. 22.

Herein, for decreasing the resolution, a smoothing filter such as a Gaussian filter is applied only to the second area for anti-aliasing and pixels in the second area are then thinned in the vertical direction as illustrated in FIG. 22. Alternatively, pixels may be thinned in the horizontal direction. Although the resolution is decreased to ½ pixels in the example illustrated in FIG. 22, the resolution decrease rate is not limited thereto and may be ⅓ pixels, ¼ pixels or 1/N pixels.

Thereafter, the preprocessor 14 outputs an area associated input image resulting from decreasing the resolution of the second area to the encoder 102, and the encoder 102 in turn performs encoding thereon.

The parameter controller 15 controls encoding parameters to assign a larger code amount to the first area than to the second area set by the area setting unit 13. More specifically, the parameter controller 15 controls the encoding parameters to assign a larger code amount when the block to be encoded belongs to the first area and to assign a smaller code amount when the block to be encoded belongs to the second area or the third area on the basis of the area information from the area setting unit 13, and outputs encoding parameter information to the encoding controller 16.

When the resolution is decreased by the preprocessor 14, the parameter controller 15 controls the encoding parameters to assign a larger code amount when the block to be encoded belongs to the first area and to assign a smaller code amount when the block to be encoded belongs to the second area or the third area further on the basis of the low-resolution area information, and outputs the encoding parameter information to the encoding controller 16.

Note that, in the second area and the third area, a larger code amount per block may be assigned to the third area or the same code amount per block may be assigned to the second area and to the third area.

The encoding controller 16 outputs encoding control information to control the encoder 102 to the encoder 102 on the basis of the encoding parameter information from the parameter controller 15. In the first embodiment, the encoding control information is a quantization parameter (hereinafter referred to as a QP) but is not limited thereto.

The encoder 102 encodes the area associated input image from the preprocessor 14 according to the QP from the encoding controller 16. Note that the encoder 102 can have a configuration compliant with H.264 or HEVC.

The subtractor 17 obtains a difference (residual) between the area associated input image and a predicted image signal to generate a prediction residual signal. The orthogonal transformer 18 performs orthogonal transform (for example, discrete cosine transform) on the prediction residual signal to convert the prediction residual signal into coefficient data. The quantizer 19 quantizes the coefficient data. The entropy coder 26 encodes a signal resulting from the quantization by the quantizer 19.

In addition, the inverse quantizer 20 and the inverse orthogonal transformer 21 perform processing inverse to the processing of the quantizer 19 and the orthogonal transformer 18 on the signal resulting from quantization by the quantizer 19, and the adder 22 adds the predicted image signal thereto to generate a locally decoded signal.

Note that the quantizer 19 and the inverse quantizer 20 perform processing on the basis of the QP from the encoding controller 16.

The locally decoded signal is stored in the frame memory 24 via the loop filter 23 and input to the predictor 25. The predictor 25 performs known motion compensated prediction to generate a predicted image signal.

Encoded data obtained by encoding by the entropy coder 26 is multiplexed by the multiplexer 27 and output as encoded data.

Note that the encoding control information may contain prediction mode information that makes the difference between the area associated input image signal and the predicted image signal “0” in the second area at the predictor 25.

Here, a decoding device for decoding the encoded data obtained by encoding by the encoding device 100 will be described. The decoding device and the transmitter 60 are assumed to be located at a predetermined destination such as a management center to which images encoded by the encoding device 100 are transmitted, but are not limited thereto.

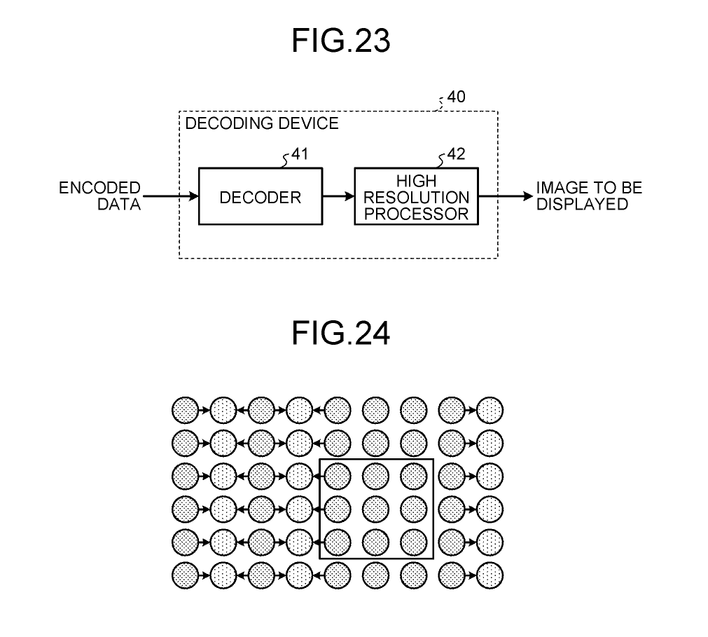

FIG. 23 is a configuration diagram illustrating an example of the decoding device 40 according to the first embodiment. As illustrated in FIG. 23, the decoding device 40 includes a decoder 41 and a high resolution processor 42.

The decoder 41 decodes encoded data obtained by encoding by the encoding device 100.

The high resolution processor 42 increases the resolution of the decoded data. Specifically, when the resolution of the second area is decreased at the encoding device 100, the high resolution processor 42 interpolates the pixels in the second area thinned for decreasing the resolution by using an interpolation filter (see FIG. 24). As a result, the image can be displayed at the same resolution as the image (input image) captured by the imager 11.

Note that the resolution may be increased to that of a displayed image so that an image is displayed at a resolution different from that of the input image.

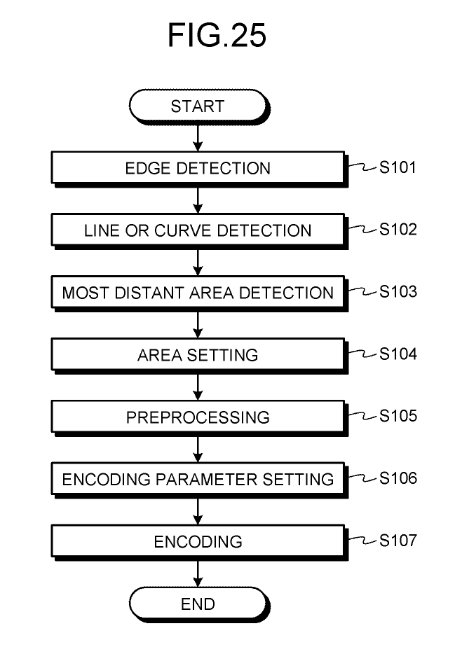

FIG. 25 is a flowchart illustrating an example of a flow of procedures of processing performed by the encoding device 100 according to the first embodiment.

First, the most distant area detector 12 performs edge detection of an object to be visually observed on an image captured by the imager 11 (step S101), performs line or curve detection on the basis of the result of edge detection (step S102), and detects an area in which most detected lines or curves intersect to be the most distant area (step S103).

Subsequently, the area setting unit 13 sets a boundary area at a predetermined distance from the imager 11 in the image captured by the imager 11, sets an area inner than the boundary area to be a first area, and sets the area outer than the boundary area to be a second area on the basis of the most distant area detected by the most distant area detector 12. The area setting unit 13 also sets an area inner than the boundary area but outside of the first area to be a third area (step S104).

Subsequently, the preprocessor 14 performs preprocessing such as image processing for improving the image quality of the first area set by the area setting unit 13 and reducing the code amounts of the second area and the third area set by the area setting unit 13. When the resolution of the second area is decreased, the preprocessor 14 outputs low-resolution area information containing the area whose resolution is decreased and the low resolution ratio to the parameter controller 15 (step S105).

Subsequently, the parameter controller 15 controls encoding parameters to assign a larger code amount to the first area than to the second area set by the area setting unit 13. When the resolution of the second area is decreased by the preprocessor 14, the parameter controller 15 controls the encoding parameters to assign a larger code amount to the first area than the second area further on the basis of the low-resolution area information (step S106)

Subsequently, the encoder 102 encodes the area associated input image from the preprocessor 14 according to the encoding control information (step S107).

According to the first embodiment as described above, a larger code amount can be assigned to an area in the vicinity of a stop position in an image on which the user (supervisor) wants to focus, and thus the influence of degradation caused by encoding on the area can be reduced and the visibility of the area can be improved.

### Second Embodiment

In the second embodiment, an example of measuring a predetermined distance will be described. In the following, differences from the first embodiment will be mainly described and components having similar functions as in the first embodiment will be designated by the same names and reference numerals as in the first embodiment, and the description thereof will not be repeated.

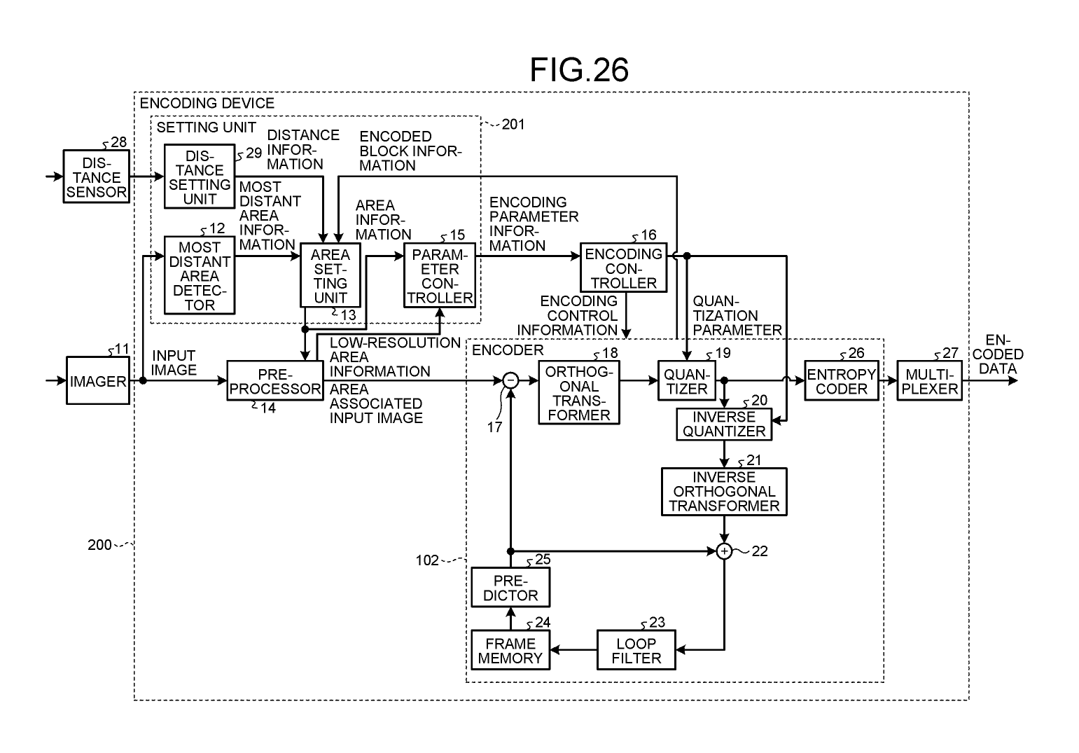

FIG. 26 is a diagram illustrating an example of the configuration of an encoding device 200 according to the second embodiment. As illustrated in FIG. 26, the encoding device 200 according to the second embodiment is different from that in the first embodiment in that a setting unit 201 includes a distance setting unit 29.

A distance sensor 28 measures the distance to each subject, and outputs the distance to the encoding device 200.

The distance setting unit 29 sets a predetermined distance on the basis of the distance from the distance sensor 28 and a preset distance from the imager 11, and outputs distance information to the area setting unit 13.

The area setting unit 13 sets a boundary area in an image on the basis of the distance information from the distance setting unit 29.

### Third Embodiment

In the third embodiment, an example of performing rate control will be described. In the following, differences from the first embodiment will be mainly described and components having similar functions as in the first embodiment will be designated by the same names and reference numerals as in the first embodiment, and the description thereof will not be repeated.

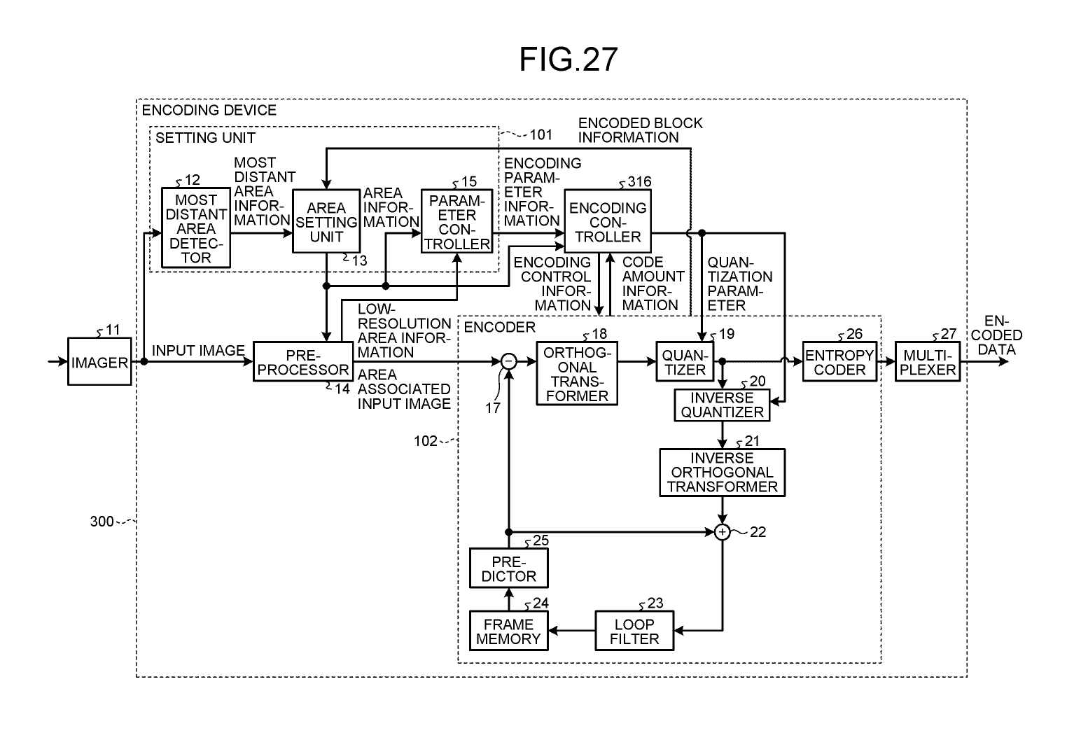

FIG. 27 is a diagram illustrating an example of the configuration of an encoding device 300 according to the third embodiment. As illustrated in FIG. 27, the encoding device 300 according to the third embodiment is different in an encoding controller 316 from that in the first embodiment.

The encoding controller 316 performs encoding rate control by using area information and code amount information. Specifically, the encoding controller 316 performs rate control on the first area to the third area on the basis of the area information from the area setting unit 13 and the code amount information from the encoder 102, and outputs encoding control information.

In this process, the encoding controller 316 performs control to assign a larger code amount to the first area and smaller code amounts to the second area and to the third area. When a maximum value of the QP is set in the second area, however, the code amount of the second area is the minimum code amount and cannot be controlled, and thus the encoding controller 316 performs rate control of the image by performing control on the first area.

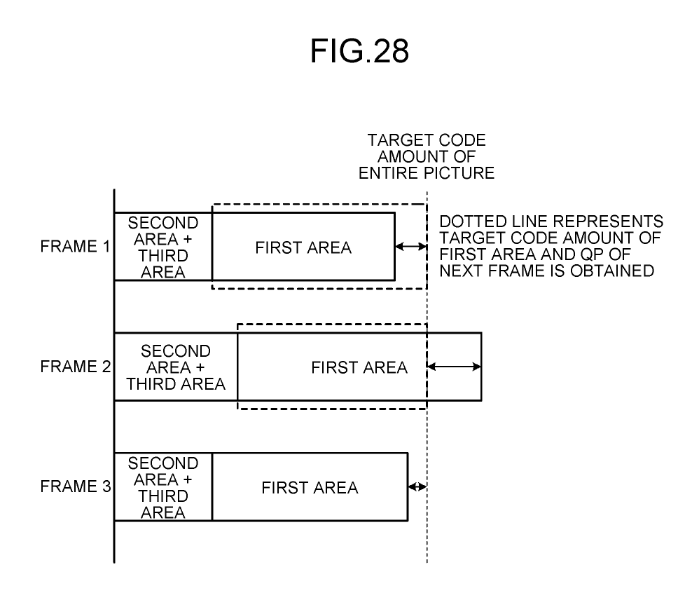

FIG. 28 is a diagram illustrating an example of the rate control method according to the third embodiment, in which the code amount of the second area cannot be controlled. In the example illustrated in FIG. 28, the encoding controller 316 performs rate control on the basis of a preset code amount per unit. Note that examples of the unit used herein include a block, a frame, a slice and a GOP. In the example illustrated in FIG. 28, it is assumed that the same code amount is assigned to the second area and to the third area.

In the example illustrated in FIG. 28, the encoding controller 316 sets a code amount obtained by subtracting the code amounts of the second area and the third area from the target amount of the entire picture (image) at a current frame to be a target code amount of the first area, and performs rate control such as setting the QP for a next frame on the basis of the target code amount of the first area and the actual code amount of the first area.

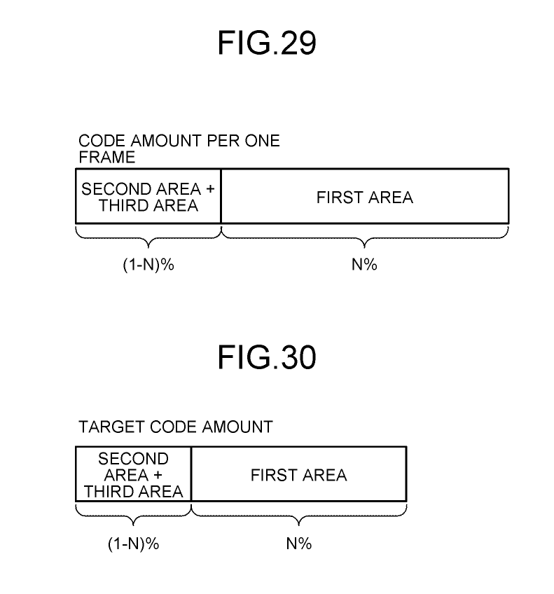

FIGS. 29 and 30 are diagrams illustrating an example of the rate control method according to the third embodiment, in which the code amount of the second area can be controlled. In this case, the encoding controller 316 performs rate control on the basis of the target code amount and the actual code amount of the entire picture (image). In this process, the encoding controller 316 may set the target code amounts of the respective areas (see FIG. 30) on the basis of the ratio of the actual code amounts of the respective area to the code amount of the entire picture (see FIG. 29). In the example illustrated in FIGS. 29 and 30, it is assumed that the same code amount is assigned to the second area and to the third area.

When scalable coding is performed, however, the encoding controller 316 may perform rate control of a next frame on the basis of the code amount of the frame at the same level whether or not the code amount of the second area can be controlled.

Furthermore, the rate control is also required when the resolution of the second area is decreased because a code amount may be assigned to the second area without rate control.

When different code amounts are assigned to the second area and to the third area, the encoding controller 316 reduces the code amounts in the order of the second area, the third area, and the first area if the code amounts area larger than the preset code amount per unit or increases the code amounts in the order of the first area, the third area, and the second area if the code amounts are smaller than the code amount per unit.

The encoder 102 encodes an image according to the result of rate control by the encoding controller 316.

According to the third embodiment as described above, a larger code amount can be assigned to the first area, the influence of degradation caused by encoding on an area on which the user (supervisor) wants to focus can be reduced, and the visibility of the area can be improved.

### Fourth Embodiment

In the fourth embodiment, an example of calculating the distance from the most distant area in an image and controlling parameters by using the distance will be described. In the following, differences from the first embodiment will be mainly described and components having similar functions as in the first embodiment will be designated by the same names and reference numerals as in the first embodiment, and the description thereof will not be repeated.

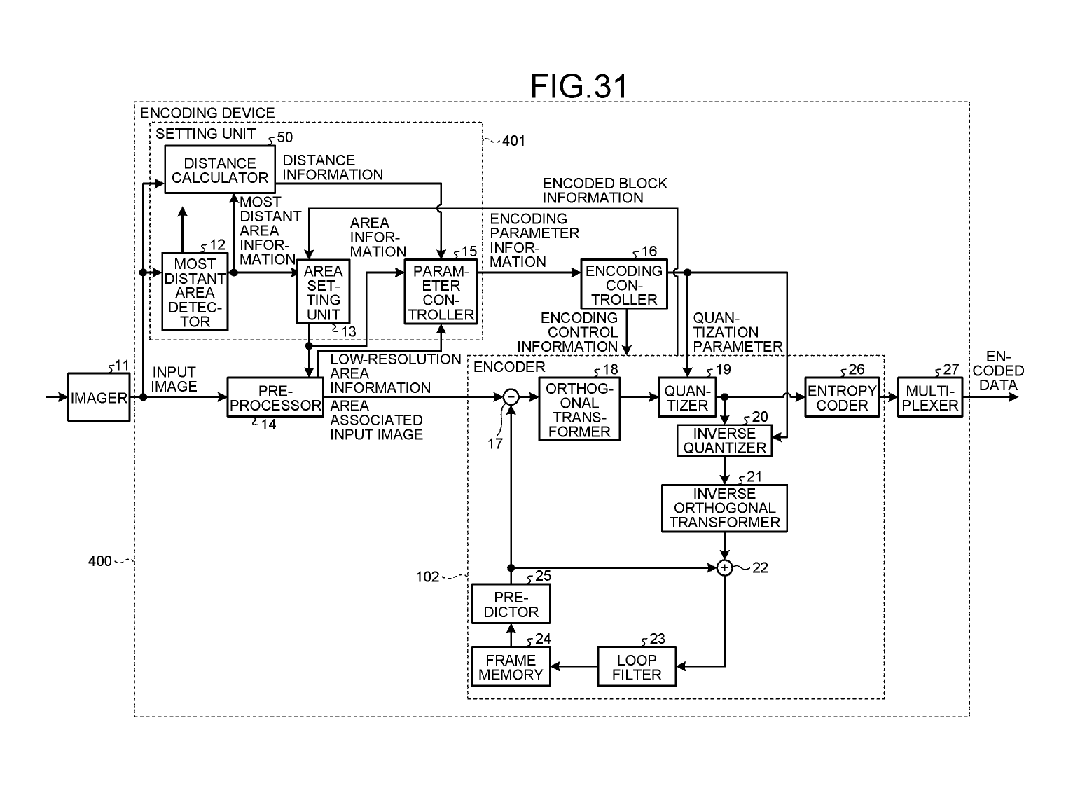

FIG. 31 is a diagram illustrating an example of the configuration of an encoding device 400 according to the fourth embodiment. As illustrated in FIG. 31, the encoding device 400 according to the fourth embodiment is different from that of the first embodiment in a distance calculator 50 of a setting unit 401.

The distance calculator 50 calculates the distance of each area in an image from the most distant area within the image. Specifically, the distance calculator 50 calculates the distance of each area in an image from the most distant area within the image by using most distant area information from the most distant area detector 12 and the image (input image) captured by the imager 11, and outputs block distance information to the parameter controller 15.

The parameter controller 15 controls encoding parameters so that a larger code amount is assigned to an area with a shorter distance from the most distant area among the first areas.

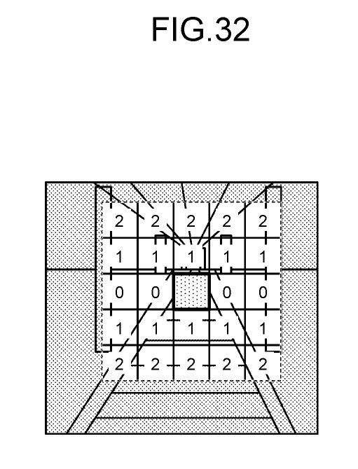

FIG. 32 is a diagram illustrating an example of the block distance information according to the fourth embodiment. In the example illustrated in FIG. 32, a block at the center represented by a thick frame is assumed to be the most distant area. In this case, since blocks at the same horizontal position in the image are likely to be at the same distance from the camera as the most distant area, the distance calculator 50 sets the blocks to 0.

The distance calculator 50 also increments the block distances one by one as positions of blocks are farther in the vertical direction from the most distant area, and the parameter controller 15 controls parameters so that a larger code amount is assigned to a block at a smaller block distance and a smaller code amount is assigned to a block at a larger block distance on the basis of this information.

Since, however, an area under the most distant area is the moving area of the mobile object, the distance calculator 50 may set a block on or under the most distant area depending on the object to be visually observed so that a larger code amount is assigned to the block. The distance calculator 50 may also increase the block distances radially from the most distant area.

According to the fourth embodiment as described above, a larger code amount can be assigned to an area closer to the most distant area among the first areas, the influence of degradation caused by encoding on an area on which the user (supervisor) wants to focus can be reduced, and the visibility of the area can be improved.

Hardware Configuration

An example of the hardware configuration of the encoding device according to the embodiments described above will be described. The encoding device according to the embodiments described above includes a control device such as a CPU, a storage device such as a ROM and a RAM, an external storage device such as an HDD, a display device such as a display, an input device such as a keyboard and a mouse, and a communication device such as a communication interface, which is a hardware configuration utilizing a common computer system.

Programs to be executed by the encoding device according to the embodiments described above are stored on a computer readable recording medium such as a CD-ROM, a CD-R, a memory card, a digital versatile disk (DVD) and a flexible disk (FD) in a form of a file that can be installed or executed, and provided therefrom.

Alternatively, the programs to be executed by the encoding device according to the embodiments described above may be stored on a computer system connected to a network such as the Internet, and provided by being downloaded via the network. Still alternatively, the programs to be executed by the encoding device according to the embodiments described above may be provided or distributed through a network such as the Internet. Still alternatively, the programs to be executed by the encoding device according to the embodiments described above may be embedded in a ROM or the like in advance and provided therefrom.

The programs to be executed by the encoding device according to the embodiments described above have modular structures for implementing the respective components described above on a computer system. In an actual hardware configuration, the CPU reads programs from the HDD and executes the programs on the RAM, whereby the respective components described above are implemented on a computer system.

For example, the order in which the steps in the flowcharts in the embodiments described above are performed may be changed, a plurality of steps may be performed at the same time or the order in which the steps are performed may be changed each time the steps are performed to the extent that the changes are not inconsistent with the nature thereof.

As described above, according to the embodiments, the influence of degradation caused by encoding on an area in an image on which the user wants to focus can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An encoding device comprising:
an area setting unit configured to, in an image captured by an imager mounted on a vehicle while the vehicle is moving along a predetermined route, set a boundary in the image at a predetermined distance from the imager, a first area being an area inside of the boundary, and a second area being an area outside of the boundary;
a parameter controller configured to control an encoding parameter to assign a larger code amount to the first area than to the second area; and
an encoder configured to encode the image in accordance with the encoding parameter.

2. The device according to claim 1, further comprising a most distant area detector configured to detect a most distant area that is an area on the path in the image and at a largest from the imager, wherein
the area setting unit sets an area inner than the boundary area to be the first area on the basis of the most distant area.

3. The device according to claim 2, wherein
the most distant area is located inner than the boundary area, and
the area setting unit draws two first lines from the most distant area to a lower side of the boundary area and sets an area surrounded by the most distant area, the lower side of the boundary area, and the two first lines to be the first area.

4. The device according to claim 3, wherein the two first lines are a line connecting a left end of a lower side of the most distant area and a left end of the lower side of the boundary area and a line connecting a right end of the lower side of the most distant area and a right end of the lower side of the boundary area.

5. The device according to claim 3, wherein the two first lines are lines along outer edges of the path.

6. The device according to any one of claim 3, wherein the two first lines are lines or curves.

7. The device according to any one of claim 3, wherein the area setting unit draws two second lines from the most distant area to an upper side of the boundary area, and sets an area surrounded by the most distant area, the upper side of the boundary area, and the two second lines to be the first area.

8. The device according to claim 7, wherein the two second lines are a line connecting a left end of an upper side of the most distant area and a left end of the upper side of the boundary area and a line connecting a right end of the upper side of the most distant area and a right end of the upper side of the boundary area.

9. The device according to claim 7, wherein the two second lines are lines along outer edges of an overhead wire.

10. The device according to claim 7, wherein the two second lines are lines connecting the most distant area and intersection points of the upper side of the boundary area and lines perpendicular thereto passing through inter sections of the two first lines and the lower side of the boundary area.

11. The device according to claim 7, wherein the two second lines are lines or curves.

12. The device according to any one of claim 3, wherein the area setting unit sets an area inner than the boundary area but outside of the first area to be a third area.

13. The device according to claim 1, further comprising a preprocessor configured to perform processing to decrease resolution of the second area in the image, wherein
the parameter controller controls an encoding parameter to assign a larger code amount to the first area than to the second area further on the basis of a result of decreasing resolution.

14. The device according to claim 1, further comprising a distance setting unit configure to set the predetermined distance on the basis of a distance from the imager.

15. The device according to claim 1, further comprising an encoding controller configured to perform rate control of encoding by using the encoding parameters, wherein
the encoding controller performs rate control to reduce code amounts in an order of the second area and the first area when a code amount of a previous frame is large, and performs rate control to increase code amounts in an order of the first area and the second area when a code amount of a previous frame is small, and
the encoder encodes the image according to a result of the rate control.

16. The device according to claim 2, further comprising a distance calculator configured to calculate a distance of each area in the image from the most distant area within the image, wherein
the parameter controller controls an encoding parameter to assign a larger code amount to an area at a shorter distance from the most distant area among the first areas.

17. The device according to claim 13, further comprising a distance calculator configured to calculate a distance of each area in the image from the most distant area within the image, wherein
the parameter controller controls an encoding parameter to assign a larger code amount to an area at a shorter distance from the most distant area among the first areas.

18. The device according to claim 14, further comprising a distance calculator configured to calculate a distance of each area in the image from the most distant area within the image, wherein
the parameter controller controls an encoding parameter to assign a larger code amount to an area at a shorter distance from the most distant area among the first areas.

19. The device according to claim 15, further comprising a distance calculator configured to calculate a distance of each area in the image from the most distant area within the image, wherein
the parameter controller controls an encoding parameter to assign a larger code amount to an area at a shorter distance from the most distant area among the first areas.

20. A monitoring system comprising:
an imager mounted on a vehicle while the vehicle is moving along a predetermined route;
an area setting unit configured to, in an image captured by the imager, set a boundary in the image at a predetermined distance from the imager, a first area being an area inside of the boundary, and a second area being an area outside of the boundary;
a parameter controller configured to control an encoding parameter to assign a larger code amount to the first area than to the second area;
an encoder configured to encode the image in accordance with the encoding parameter; and
a decoder configured to decode the image.
